(19) United States
(12) Patent Application Publication
(10) Pub. No.: US 2017/0009093 A1
(43) Pub. Date: Jan. 12, 2017

(54) LIQUID COMPOSITION, PIGMENT DISPERSION LIQUID, AND INK JET RECORDING AQUEOUS INK COMPOSITION

(71) Applicant: Seiko Epson Corporation, Tokyo (JP)

(72) Inventor: Hiroshi ITO, Matsumoto (JP)

(21) Appl. No.: 15/175,410

(22) Filed: Jun. 7, 2016

(30) Foreign Application Priority Data
Jul. 6, 2015 (JP) 2015-134945

(51) Int. Cl. C09D 11/324; C09D 11/328; C09D 11/30

(52) U.S. Cl. CPC C09D 11/324; C09D 11/30; C09D 11/328

(57) ABSTRACT

A liquid composition contains a first solvent that is a propanediol compound having a water-octanol partition coefficient in the range of 0.5 to 2.0 and containing a phenoxy or a benzyloxy group, a second solvent that is a water-soluble organic solvent having a water-octanol partition coefficient in the range of −1.0 to 1.0, water, and a coloring material. The first solvent content is in the range of 0.05% by mass to 0.5% by mass, and the second solvent content is in the range of 0.5% by mass to 15% by mass.

### BACKGROUND

1. Technical Field

The present invention relates to an liquid composition, and a pigment dispersion liquid and an ink jet recording aqueous ink composition that contain the liquid composition.

2. Related Art

An ink jet recording method allows high-definition images to be formed with a relatively simple apparatus and is accordingly being rapidly developed in a various fields. Unfortunately, aqueous ink compositions (hereinafter simply referred to as ink) can cause microorganisms to grow during the storage thereof. If microorganisms grow in an ink, the microorganisms can decrease the pH of the ink or cause some of the constituents of the ink to precipitate, thereby causing the ink to deteriorate or to clog nozzles. Accordingly, studies for improving the preservative effect of inks have been made.

For example, JP-A-2011-46624 discloses the use of 1,2-benzisothiazolin-3-one as a preservative and antibacterial agent in a liquid composition. JP-A-2003-183558 discloses a technique in which Proxel XL2S is added as a preservative and fungicide to an ink jet aqueous pigment ink. Furthermore, JP-A-2010-222417 discloses an aqueous ink composition prepared by heat-treating a pigment dispersion liquid containing sodium benzoate or the like as a preservative and fungicide and further glycerol ether compound as a wetting agent.

Unfortunately, the above-cited preservative and fungicides are biocidal. If labels, textiles, or the like printed with an ink containing such a preservative and fungicide are brought into contact with skin, the ink can cause skin sensitization depending on the use. Since the minimum inhibitory concentration of preservatives and fungicides to microorganisms is, for example, about several tens ppm to several hundred ppm, the content thereof in an ink is not more than about 500 ppm, and the ink itself is therefore safe. When the liquid component has been removed from the ink after printing, however, the preservative and fungicide is concentrated to about 10 to 20 times the concentration immediately after being added to the ink.

In addition, a material not easily evaporating or dissolving again after drying is used as the preservative and fungicide from the viewpoint of maintaining the preservative effect thereof. Therefore the preservative and fungicide is liable to remain on the printed surface. Accordingly, if the printing medium is, for example, a film, the preservative is likely to be concentrated on the printed surface. Also, printed articles such as labels and textiles easily come in contact with skin when used. Therefore inks used in these printed articles can cause skin sensitization and result in allergic contact dermatitis. A safer ink is demanded.

Although sodium benzoate used in the above cited JP-A-2010-222417 is a relatively safe preservative and fungicide, a still safer agent is demanded. Sodium benzoate, which is an ionic compound, is likely to make the dye insoluble or cause the dispersed pigment to form an aggregate, thus degrading the stability of the ink.

### SUMMARY

An advantage of some aspects of the invention is that it provides a liquid composition that does not have the risk of skin sensitization and is thus safe while being satisfactorily prevented from rotting and thus stable.

The subject matter of the invention can be achieved in the following embodiments or applications.

### Application 1

According to an aspect of the invention, a liquid composition is provided. The liquid composition contains a first solvent that is a propanediol compound having a water-octanol partition coefficient in the range of 0.5 to 2.0 and containing a phenoxy or a benzyloxy group, a second solvent that is a water-soluble organic solvent having a water-octanol partition coefficient in the range of −1.0 to 1.0, water, and a coloring material. The first solvent content is in the range of 0.05% by mass to 0.5% by mass, and the second solvent content is in the range of 0.5% by mass to 15% by mass.

The liquid composition does not have the risk of causing skin sensitization and is thus safe while being prevented from rotting and thus stable.

### Application 2

The first solvent may be at least one selected from the group consisting of phenyl glyceryl ether, 2-methyl-3-phenoxy-1, 2-propanediol, 3-benzyloxy-1,2-propanediol, and 2-hydroxymethyl-2-phenoxymethyl-1,3-propanediol.

### Application 3

The second solvent may be at least one selected from the group consisting of 1,2-alkyldiols and glycol ether-based water-soluble organic solvents.

### Application 4

The 1,2-alkyldiols may include 1,2-butanediol, 3,3-dimethylbutane-1, 2-diol, 1,2-pentanediol, 1,2-hexanediol, and 1,2-heptanediol.

### Application 5

The glycol ether-based water-soluble organic solvents may include ethyl triglycol, dipropylene glycol monomethyl ether, butyl triglycol, butyl diglycol, and dipropylene glycol monopropyl ether.

### Application 6

The water content in the liquid composition may be 40% by mass or more.

### Application 7

According to another aspect of the invention, a pigment dispersion liquid containing the above-described liquid composition is provided.

### Application 8

According to still another aspect of the invention, an ink jet recording aqueous ink composition containing the above-described liquid composition is provided.

### DESCRIPTION OF EXEMPLARY EMBODIMENTS

Embodiments of the invention will now be described. The following embodiments will be described by way of example. The invention is not limited to the following embodiments, and various modifications may be made within the scope and spirit of the invention. Not all the components disclosed in the following embodiments are required for the invention.

### 1. Liquid Composition

The liquid composition according to an embodiment of the invention is intended for use as a pigment dispersion liquid and an ink jet recording aqueous ink composition (hereinafter simply referred to as ink) and contains a first solvent that is a propanediol compound having a water-octanol partition coefficient in the range of 0.5 to 2.0 and containing a phenoxy or a benzyloxy group, a second solvent that is a water-soluble organic solvent having a water-octanol partition coefficient in the range of −1.0 to 1.0, water, and a coloring material. In the liquid composition, the first solvent content is in the range of 0.05% by mass to 0.5% by mass, and the second solvent content is in the range of 0.5% by mass to 15% by mass. The constituents of the liquid composition will now be described in detail.

### 1. 1. First Solvent

The liquid composition of the present embodiment contains 0.05% by mass to 0.5% by mass of a first solvent. The first solvent is a propanediol compound having a water-octanol partition coefficient in the range of 0.5 to 2.0 and containing a phenoxy or a benzyloxy group.

The propanediol compounds having a water-octanol partition coefficient in the range of 0.5 to 2.0 and having a phenoxy or a benzyloxy group are additives used in food and cosmetics and are known as solvents having no risk of skin sensitization. On the other hand, they have some antibacterial effect on bacterial, such as Escherichia coli and Pseudomonas aeruginosa, and some antifungal effect on Eumycetes, such as Aspergillus oryzae and Penicillium funiculosum. Accordingly, the liquid composition containing the first solvent can be satisfactorily prevented from rotting even though a known biocidal antibacterial agent or fungicide is not added. Thus, the liquid composition does not have the risk of causing skin sensitization and is thus safe while being prevented from rotting.

Propanediol compounds having a phenoxy or a benzyloxy group and having a water-octanol partition coefficient in the range of 0.5 to 2.0 are nonionic and therefore do not cause the dye used as the coloring material to become insoluble or cause the pigment dispersed in the composition to form an aggregate. Also, when such a propanediol compound is used in combination with the second solvent, the liquid composition can be stable and particularly in low-temperature stability.

The water-octanol partition coefficient, or log P value, is a value defined by OECD Test Guideline 107. The higher the log P of a compound is, the more hydrophobic the compound is; the lower the log P is, the more hydrophilic the compound is.

The log P value of the propanediol compound used in the liquid composition is in the range of 0.5 to 2.0, preferably in the range of 0.6 to 1.8, and more preferably in the range of 0.7 to 1.7. When the log P value of the propanediol compound is in such a range, the liquid composition can be satisfactorily prevented from rotting.

Examples of the propanediol compound having a water-octanol partition coefficient in the range of 0.5 to 2.0 and containing a phenoxy or a benzyloxy group include, but are not limited to, 2-hydroxymethyl-2-phenoxymethyl-1,3-propanediol (log P: 1.69), phenyl glyceryl ether (log P: 0.75), 3-benzyloxy-1,2-propanediol (log P: 0.88), 2-methyl-3-phenoxy-1,2-propanediol (log P: 1.10), 3-(3-methylphenoxy)-1, 2-propanediol (log P: 1.21), and 3-(4-methoxybenzyloxy)-1, 2-propanediol (log P: 0.80). These solvents may be used singly or in combination. From the viewpoint of ensuring antibacterial effect and antifungal effect in a low content, phenyl glyceryl ether and 3-benzyloxy-1, 2-propanediol are advantageous.

The content of the first solvent is in the range of 0.05% by mass to 0.5% by mass, preferably in the range of 0.05% by mass to 0.3% by mass, and more preferably in the range of 0.05% by mass to 0.1% by mass, relative to the total mass of the liquid composition from the viewpoint of miscibility with the second solvent and of ensuring antibacterial effect and antifungal effect.

### 1. 2. Second Solvent

The liquid composition of the present embodiment contains 0.5% by mass to 15% by mass of a second solvent. The second solvent is a water-soluble organic solvent having a water-octanol partition coefficient in the range of −1.0 to 1.0.

The first solvent used in the liquid composition of the present embodiment, which has a water-octanol partition coefficient in the range of 0.5 to 2.0 and contains a phenoxy or a benzyloxy group, has a relatively high log P value and is thus hydrophobic. If the liquid composition contains water with a high proportion, the first solvent is likely to separate as oil phases in the liquid composition, thus making the liquid composition unstable. Accordingly, in the present embodiment, the second solvent having a higher log P value than the propanediol compound containing a phenoxy or a benzyloxy group used as the first solvent is added to the liquid composition so that the first solvent is miscible in the liquid composition, thereby ensuring the stability of the liquid composition. Consequently, the liquid composition can be stable, particularly in low-temperature stability, while being satisfactorily prevented from rotting even though a known biocidal preservative or fungicide is not added.

Ink jet recording inks, which desirably have relatively low viscosities in view of ejection stability, contain water with a relatively high proportion. Accordingly, the stability of the hydrophobic component in the ink is likely to decrease, and consequently, the ejection stability of the ink is reduced. In an ink jet recording aqueous ink using the liquid composition of the present embodiment, however, the hydrophobic first solvent can be stably miscible because of the presence of the second solvent. Accordingly, the ink jet recording aqueous ink containing the liquid composition does not cause the first solvent or the like to precipitate or to clog nozzles, thus ensuring ejection stability.

The log P value of the water-soluble organic solvent used as the second solvent in the liquid composition is in the range of −1.0 to 1.0, preferably in the range of −0.5 to 0.8, and more preferably in the range of 0.0 to 0.7. When the log P value of the water-soluble organic solvent used as the second solvent is in such a range, the organic solvent is miscible with the first solvent and the resulting liquid composition can be stable. If the log P value of the water-soluble organic solvent is lower than −1.0, the organic solvent is less miscible with the first solvent and the resulting liquid composition may be unstable.

The water-soluble organic solvent as the second solvent is desirably at least one selected from the group consisting of 1,2-alkyldiols and glycol ether-based water-soluble organic solvents. Since these solvents have a structure similar to the structure of the propanediol compound used as the first solvent and are therefore miscible with the first solvent, the resulting liquid composition can be stable.

Exemplary 1,2-alkyldiols having a water-octanol partition coefficient in the range of −1.0 to 1.0 include, but are not limited to, 1,2-butanediol (log P: −0.34), 3,3-dimethylbutane-1,2-diol (log P: −0.11), 1,2-pentanediol (log P: 0.01), 1,2-hexanediol (log P: 0.70), and 1,2-heptanediol (log P: 1.0). These solvents may be used singly or in combination, and may be used as a mixture with a glycol ether-based water-soluble organic solvent. Among these 1,2-hexanediol enables the resulting liquid composition to exhibit satisfactory stability even when used with a low content and is thus particularly advantageous.

Exemplary glycol ether-based water-soluble organic solvents having a water-octanol partition coefficient of −1.0 to 1.0 include, but are not limited to, ethyl triglycol (log P: −0.98), dipropylene glycol monomethyl ether (log P: −0.46), butyl triglycol (log P: 0.02), butyl diglycol (log P: 0.56), and dipropylene glycol monopropyl ether (log P: 0.60). These solvents may be used singly or in combination. Butyl triglycol enables the resulting liquid composition to exhibit satisfactory stability even when used with a low content and is thus particularly advantageous.

The content of the second solvent can be set according to comprehensive evaluation of the hydrophobicity and content of the first solvent and is in the range of 0.5% by mass to 15% by mass, preferably in the range of 1% by mass to 10% by mass, and more preferably in the range of 2% by mass to 9% by mass, relative to the total mass of the liquid composition. When the content of the second solvent is in such a range, the organic solvent is miscible with the first solvent and the resulting liquid composition can be stable.

### 1. 3. Coloring Material

The liquid composition of the present embodiment contains a coloring material. The coloring material may be a pigment or a dye.

The pigment may be inorganic or organic. Examples of the inorganic pigment that can be used include, but are not limited to, carbon blacks (C.I. Pigment Black 7) such as furnace black, lamp black, acetylene black, and channel black, iron oxide, titanium oxide, zinc oxide, and silica.

Examples of the organic pigment that can be used include, but are not limited to, quinacridone pigments, quinacridonequinone pigments, dioxazine pigments, phthalocyanine pigments, anthrapyrimidine pigments, anthanthrone pigments, indanthrone pigments, flavanthrone pigments, perylene pigments, diketopyrrolopyrrole pigments, perinone pigments, quinophthalone pigments, anthraquinone pigments, thioindigo pigments, benzimidazolone pigments, isoindolinone pigments, azomethine pigments, and azo pigments.

The pigment may be dispersed with a known dispersant selected from among water-soluble resins, water-dispersible resins, and surfactants or may be surface-oxidized or surface-sulfonated with ozone, hypochlorous acid, fuming sulfuric acid, or the like so as to be self-dispersible. The above-cited pigments may be used singly or in combination.

Examples of the dye used as the coloring material include, but are not limited to, water-soluble dyes, such as acid dyes, direct dyes, reactive dyes, and basic dyes; and water-dispersion dyes, such as dispersion dyes and oil colors. More specifically, exemplary acid dyes include C.I. Acid Yellows 17, 23, 42, 44, 79, and 142; C.I. Acid Reds 52, 80, 82, 249, 254, and 289; C.I. Acid Blues 9, 45, and 249; and C.I. Acid Blacks 1, 2, 24, and 94. Exemplary direct dyes include C.I. Direct Yellows 1, 12, 24, 33, 50, 55, 58, 86, 132, 142, 144, and 173; C.I. Direct Reds 1, 4, 9, 80, 81, 225, and 227; C.I. Direct Blues 1, 2, 15, 71, 86, 87, 98, 165, 199, and 202; C.I. Direct Blacks 19, 38, 51, 71, 154, 168, and 195; and C.I. Direct Blues 2, 3, 8, 10, 12, 31, 35, 63, 116, 130, 149, 199, 230, and 231. Exemplary reactive dyes include C.I. Reactive Yellows 2, 7, 15, 22, 37, 42, 57, 69, 76, 81, 95, 102, 125, and 135; C.I. Reactive Reds 2, 14, 24, 32, 55, 79, 106, 111, and 124; C.I. Reactive Blues 2, 13, 21, 38, 41, 50, 69, 72, 109, 120, and 143; and C.I. Reactive Blacks 3, 4, 5, 8, 13, 14, 31, 34, 35, and 39. Exemplary basic dyes include C.I. Basic Yellows 1, 2, 13, 19, 21, 25, 32, 36, 40, and 51; C.I. Basic Reds 1, 5, 12, 19, 22, 29, 37, 39, and 92; C.I. Basic Blues 1, 3, 9, 11, 16, 17, 24, 28, 41, 45, 54, 65, and 66; and C.I. Basic Blacks 2 and 8. Exemplary dispersion dyes include C.I. Disperse Reds 60, 82, 86, 86:1, 167:1, and 279; C.I. Disperse Yellows 64, 71, 86, 114, 153, 233, and 245; C.I. Disperse Blues 27, 60, 73, 77, 77:1, 87, 257, and 367; C.I. Disperse Violets 26, 33, 36, and 57; and C.I. Disperse Oranges 30, 41, and 61. Exemplary oil colors include C.I. Solvent Yellows 16, 21, 25, 29, 33, 51, 56, 82, 88, 89, 150, and 163; C.I. Solvent Reds 7, 8, 18, 24, 27, 49, 109, 122, 125, 127, 130, 132, 135, 218, 225, and 230; C.I. Solvent Blues 14, 25, 35, 38, 48, 67, 68, 70, and 132; and C.I. Solvent Blacks 3, 5, 7, 27, 28, 29, and 3.

These dyes may be used singly or in combination. The dye may be used as a mixture with a pigment.

The coloring material content can be adjusted depending on the use of the liquid composition, and is preferably in the range of 0.10% by mass to 20.0% by mass, more preferably in the range of 0.20% by mass to 15.0% by mass, and still more preferably in the range of 1.0% by mass to 10.0% by mass.

### 1. 4. Water

The liquid composition of the present embodiment contains water. The water may be pure water or ultra pure water from which ionic impurities have been removed as much as possible. Examples of such water include ion exchanged water, ultrafiltered water, reverse osmosis water, and distilled water. Sterile water prepared by, for example, UV irradiation or addition of hydrogen peroxide can prevent the occurrence of bacteria and Eumycetes in the liquid composition over a long time.

The water content is preferably 40% by mass or more, more preferably 45% by mass or more, and still more preferably 50% by mass or more, relative to the total mass of the liquid composition. When the water content is 40% by mass or more, the liquid composition has a relatively low viscosity. When the water content is 40% by mass or more, the solubility of the hydrophobic first solvent is likely to decrease. However the second solvent miscible with the first solvent increases the stability of the liquid composition. The upper limit of the water content is preferably 90% by mass or less, more preferably 85% by mass or less, and still more preferably 80% by mass or less, relative to the total mass of the liquid composition.

### 1. 5. Moisturizing Agent

The liquid composition of the present embodiment may further contain a moisturizing agent. Any moisturizing agent generally used in ink jet recording ink compositions can be used without particular limitation. The moisturizing agent preferably has a normal boiling point of 180° C. or more. For a liquid composition used for inks that can be dried by evaporation, the normal boiling point is preferably in the range of 180° C. to 250° C.; for a liquid composition used for inks that can be dried by penetration, the normal boiling point is preferably 200° C. or more. The moisturizing agent having a normal boiling point in such a range can impart good water retention and wettability to the ink composition.

Examples of the moisturizing agent include, but are not limited to, polyols, such as ethylene glycol, propylene glycol, diethylene glycol, triethylene glycol, tetraethylene glycol, pentamethylene glycol, trimethylene glycol, 2-butene-1,4-diol, 2-ethyl-1,3-hexanediol, 2-methyl-2,4-pentanediol, tripropylene glycol, polyethylene glycol having a number average molecular weight of 2000 or less, 1,3-propylene glycol, isopropylene glycol, isobutylene glycol, glycerin, diglycerin, mesoerythritol, trimethylolpropane, pentaerythritol, and dipentaerythritol; lactams, such as 2-pyrrolidone, N-methyl-2-pyrrolidone, E-caprolactam, and hydroxyethylpyrrolidone; urea and derivative thereof, such as thiourea, ethyleneurea, and 1,3-dimethylimidazolidinone; monosaccharides, disaccharides, oligosaccharides and polysaccharides, such as glucose, mannose, fructose, ribose, xylose, arabinose, galactose, aldonic acid, glucitol (sorbitol), maltose, cellobiose, lactose, sucrose, trehalose, and maltotriose, and derivatives of these saccharides; and betaines, such as glycine and trimethylglycine. Propylene glycol, glycerin, and trimethylolpropane are particularly suitable.

Those moisturizing agents may be used singly or in combination.

The moisturizing agent content can be adjusted depending on the use of the liquid composition, and is preferably in the range of 2.5% by mass to 30% by mass, more preferably in the range of 5.0% by mass to 25% by mass, and still more preferably in the range of 10% by mass to 20% by mass, relative to the total mass of the ink prepared using the liquid composition.

### 1. 6. Surface Tension Adjuster

The liquid composition of the present embodiment may further contain a surface tension adjuster. The surface tension adjuster is used for reducing the surface tension of ink to adjust the wettability of the ink to printing media, ejection paths, and ejection heads and is selected from among water-soluble solvents having a low surface tension and surfactants.

Exemplary water-soluble solvents having a low surface tension include, but are not limited to, lower alcohols, such as ethanol, propanol, and butanol; diols, such as butylene glycol, 1,3-pentanediol, 2-ethyl-1,3-propanediol, and 1,6-hexanediol; glycol monoethers, such as ethylene glycol monomethyl ether, ethylene glycol monoethyl ether, diethylene glycol monomethyl ether, diethylene glycol monoethyl ether, and propylene glycol monomethyl ether. Exemplary surfactants include, but are not limited to, nonionic surfactants, anionic surfactants, cationic surfactants, and amphoteric surfactants. Acetylene glycol-based surfactants and silicone surfactants are advantageous. These surfactants have high surface activity and are less foamable.

Acetylene glycol-based surfactants include, but are not limited to, Olfine series E 1004, E 1010, E 1020, PD-001, PD-002W, PD-004, PD-005, EXP. 4200, EXP. 4123, and EXP. 4300 (each produced by Nissin Chemical Industry), Surfynol series 440, 465, 485, CT 111, CT 121, TG, and GA, Dynol series 604 and 607, and Surfynol 104 series (each produced by Air Products), and Acetylenol series E40, E60, and E100 (each produced by Kawaken Fine Chemicals). Acetylene glycol-based surfactants may be used singly or in combination.

Silicone surfactants include polysiloxane compounds such as polyether-modified organosiloxane. Commercially available silicone surfactants include, but are not limited to, BYK-306, BYK-307, BYK-333, BYK-341, BYK-345, BYK-346, BYK-347, BYK-348, and BYK-349 (each produced by BYK); KF-351A, KF-352A, KF-353, KF-354L, KF-355A, KF-615A, KF-945, KF-640, KF-642, KF-643, KF-6020, X-22-4515, KF-6011, and KF-6012 (each produced by Nissin Chemical Industry); and Silface series SAG002, 005, 503A, and 008 (each produced by Nissin Chemical Industry).

The surface tension adjuster content can be adjusted depending on the use of the liquid composition, and is preferably in the range of 0.10% by mass to 2.5% by mass, more preferably in the range of 0.25% by mass to 1.5% by mass, and still more preferably in the range of 0.50% by mass to 1.25% by mass, relative to the total mass of the ink prepared using the liquid composition. When the surface tension adjuster content is in such a range, the wettability to recording media of the ink prepared using the liquid composition can be appropriately controlled.

### 1. 7. pH Adjuster

The liquid composition of the present embodiment may further contain a pH adjuster so as to control the pH of inks. Examples of the pH adjuster include, but are not limited to, inorganic acids, such as sulfuric acid, hydrochloric acid, and nitric acid; inorganic bases, such as lithium hydroxide, sodium hydroxide, potassium hydroxide, and ammonia; organic bases, such as triethanolamine, diethanolamine, monoethanolamine, triisopropanolamine, diisopropanolamine, tris(hydroxymethyl)aminomethane; and organic acids, such as adipic acid, citric acid, succinic acid, and lactic acid.

pH adjusters may be used singly or in combination.

The pH adjuster content can be adjusted depending on the use of the liquid composition, and the pH adjuster is added so that the ink has a pH preferably in the range of 6.5 to 10.5, more preferably in the range of 7.0 to 9.5.

### 1. 8. Fixing Resin

The liquid composition of the present embodiment may contain a fixing resin. The fixing resin is added typically when a pigment is used as the coloring material, and is intended to increase the fixability of the pigment to recording media.

The fixing resin may be a water-soluble resin or a water-dispersible resin, and examples of the fixing resin include, but are not limited to, acrylic polymers, such as polyacrylic esters and copolymers thereof, polymethacrylic esters and copolymers thereof, polyacrylonitrile and copolymers thereof, polycyanoacrylates, polyacrylamides, polyacrylic acids, and polymethacrylic acids. Polyolefin polymers may be used, such as polyethylene, polypropylene, polybutene, polyisobutylene, polystyrene, and copolymers thereof, petroleum resin, coumarone, indene resin, and terpene resin. Vinyl acetate or vinyl alcohol polymers may be used, such as polyvinyl acetate and copolymers thereof, polyvinyl alcohols, polyvinyl acetals, and polyvinyl ethers. Halogen-containing polymers may be used, such as polyvinyl chloride and copolymers thereof and polyvinylidene chloride. Nitrogen-containing vinyl polymers may be used, such as polyvinylcarbazole, polyvinylpyrrolidone and copolymers thereof, polyvinylpyridine, and polyvinylimidazole. Diene polymers may be used, polybutadiene and copolymers thereof, polychloroprene, and polyisoprene (butyl rubber). Ring-opening-polymerized resins, condensation-polymerized resins, and natural macromolecules may be used.

Fixing resins may be used singly or in combination.

The fixing resin content can be adjusted depending on the use of the liquid composition, and is preferably in the range of 1.5% by mass to 5% by mass, relative to the total mass of the liquid composition. When the fixing resin content is in this range, the adhesion of the pigment to recording media is increased.

### 1. 9. Other Constituents

In order to maintain the good storage stability of the liquid composition and good ejection thereof from the head, and also in order to prevent the deterioration of the liquid composition, the liquid composition may optionally contain other additives, such as solubilizing agent, a viscosity modifier, an antioxidant, and a chelating agent for capturing metal ions affecting the dispersion.

### 1. 10. Preparation of Liquid Composition

The liquid composition of the present embodiment can be prepared by mixing the above-described constituents. The process for mixing is not particularly limited, and a known process may be applied. For preparing an ink jet recording pigment dispersion liquid and aqueous ink composition according to an embodiment of the present invention, the liquid composition may be used in the form as it is or after being mixed with, for example, water or a solvent and other additives.

### 1. 11. Use

The liquid composition of the present embodiment can be used as an ink jet recording pigment dispersion liquid and aqueous ink composition in the form as it is or after being mixed with, for example, water or a solvent and other additives, as described above. The ink jet recording aqueous ink composition according to an embodiment of the invention may be used for a variety of recording media including ink-absorbent cloth made of, for example, cotton, silk, polyester, polyurethane, or nylon, ink-absorbent ink jet paper, moderately absorbent fine quality paper, copy paper, and poorly absorbent or nonabsorbent coated paper or plastic films.

The poorly absorbent recording medium may be, but is not limited to, coated paper including a coating layer formed by applying a paint on the surface thereof. The coated paper may be, but is not limited to, book-printing paper, such as art paper, coat paper, or matte paper.

The nonabsorbent recording medium may be, but is not limited to, a plastic film not provided with an ink-absorbing layer, or a paper sheet or any other base material coated with a plastic film. The plastic mentioned here may be polyvinyl chloride, polyethylene terephthalate, polycarbonate, polystyrene, polyurethane, polyethylene, or polypropylene.

More specifically, a poorly absorbent or a nonabsorbent recording medium mentioned herein is such that the recording surface of the medium can absorb water at 10 mL/m² or less for a period of 30 ms from the beginning of contact with water when measured by Bristow's method. The Bristow's method is broadly used as a method for measuring liquid absorption for a short time, and Japan Technical Association of the Pulp and Paper Industry (JAPAN TAPPI) has officially adopted this method. Details of this method are specified in Standard No. 51 (Paper and Paperboard—Liquid Absorption Test Method—Bristow's Method (in Japanese)) of JAPAN TAPPI Paper and Pulp Test Methods edited in 2000 (in Japanese).

### 2. EXAMPLES

The above-described embodiments of the invention will now be further described in detail with reference to Examples and Comparative Examples. However, the invention is not limited to the Examples.

### 2. 1. Preparation of Ink Jet Recording Aqueous Ink Composition

First, ink jet recording aqueous ink compositions (hereinafter referred to as ink composition(s)) were prepared for evaluating the liquid composition. The constituents used in the ink compositions of Examples and Comparative Examples are shown in Table 1.

TABLE 1

| Constituents and contents | | Example | Example | Example | Example | Example | Example | Comparative | Comparative | Comparative |
|---|---|---|---|---|---|---|---|---|---|---|
| of ink composition (mass %) | | 1 | 2 | 3 | 4 | 5 | 6 | Example 1 | Example 2 | Example 3 |
| First | 2-Hyroxymethyl-2- | 0.5 | — | — | — | — | 0.1 | 0.5 | — | — |
| solvent | phenoxymethyl-1,3- | | | | | | | | | |
| | propanediol (log P: 1.69) | | | | | | | | | |
| | Phenyl glyceryl ether | — | 0.5 | 0.5 | 0.5 | — | — | — | — | — |
| | (log P: 0.75) | | | | | | | | | |
| | 3-Benzyloxy-1,2-propanediol | — | — | — | — | 0.05 | — | — | — | — |
| | (log P: 0.88) | | | | | | | | | |
| Second | Ethyl triglycol (log P: −0.98) | 15 | 9 | 10 | — | — | — | — | 9 | 10 |
| solvent | 1,2-Hexanediol (log P: 0.7) | — | 1 | — | 0.5 | 2 | 5 | — | 1 | — |
| | Butyl triglycol (log P: 0.02) | — | — | — | — | 2 | 5 | — | — | — |
| Sodium benzoate (log P: −2.27) | | — | — | — | — | — | — | — | — | 0.5 |
| Methyl tetraglycol (log P: −1.87) | | — | — | — | — | — | — | 15 | — | — |
| Coloring | Carbon Black MA77 | 6 | 6 | 6 | 6 | — | — | 6 | 6 | 6 |
| material | Direct Blue 199 | — | — | — | — | 4 | 4 | — | — | — |
| Moisturizing | Propylene glycol | — | 2 | — | 20 | — | — | — | 2 | — |
| agent | Glycerin | 5 | 10 | 10 | — | 15 | 12 | 5 | 10 | 10 |
| | Trimethylolpropane | 5 | 4 | 5 | — | 5 | 3 | 5 | 4 | 5 |
| Surface | BYK-348 | 1.5 | 1.5 | 1.5 | 1.5 | — | — | 1.5 | 1.5 | 1.5 |
| tension | Olfine E 1010 | — | — | — | — | 1.2 | 1.2 | — | — | — |
| expansion | | | | | | | | | | |
| adjuster | | | | | | | | | | |
| pH adjuster | Tripropanolamine | 0.2 | 0.2 | 0.2 | 0.2 | 0.5 | 0.5 | 0.2 | 0.2 | 0.2 |
| Resin | Acrylate-acrylic acid resin | 1.5 | 1.5 | 1.5 | 1.5 | — | — | 1.5 | 1.5 | 1.5 |

| | | | | | | | | | |
|---|---|---|---|---|---|---|---|---|---|
| Pure water | Balance | Balance | Balance | Balance | Balance | Balance | Balance | Balance | Balance |

The constituents of each ink composition were mixed and stirred so that the resulting mixture would have the composition shown in Table 1, and the mixture was filtered through a membrane filter with a pore size of 5 μm. Thus, ink compositions were prepared. The values in Tables 1 are on a percent-by-mass basis, and the total content of each composition is 100.0% by mass.

The constituents shown in Table 1 were as below, and the log P values in Table 1 were determined in accordance with OECD Test Guideline 107.
(1) First solvents

2-Hydroxymethyl-2-phenoxymethyl-1,3-propanediol (log P: 1.69

Phenyl glyceryl ether (log P: 0.75)

3-Benzyloxy-1,2-propanediol (log P: 0.88)
(2) Second solvents

Ethyl triglycol (log P: −0.98)

1,2-Hexanediol (log P: 0.7)

Butyl triglycol (log P: 0.02)
(3) Sodium benzoate (log P: −2.27)
(4) Methyl tetraglycol (log P: −1.87)
(5) Coloring materials

Carbon Black MA77 (product name, black pigment, produced by Mitsubishi Chemical)

Direct Blue 199 (Basacid Blue NB748 (product name), produced by BASF, cyan dye)
(6) Moisturizing agents

Propylene glycol

Glycerin

Trimethylolpropane
(7) Surface tension adjusters

BYK-348 (silicone surfactant, produced by BYK)

Olfine E 1010 (acetylene glycol-based surfactant, produced by Nissin Chemical Industry)
(8) pH adjuster

Triisopropanolamine
(9) Resin

Acrylic ester-methacrylic acid resin (JONCRYL 682 (product name), produced by BASF)

### 2. 2. Evaluations of Ink Compositions

### 2. 2. 1. Preservative Effect

Each of the ink compositions of Examples and Comparative Examples was inoculated with test strains (bacteria and Eumycetes) so that the number of colonies could be about 10⁵ CFU/g. After the sample was allowed to stand at 25° C. for 24 hours, the count of viable bacteria or fungal cells was measured. The results were rated according to the following criteria:

### Test Strains

Escherichia coli, Pseudomonas aeruginosa, Aspergillus oryzae, and Penicillium funiculosum

### Criteria

Initial: 100,000 CFU/g

A: less than 100 CFU/g

B: 100 CFU/g to less than 1,000 CFU/g

C: 1,000 CFU/g to less than 10,000 CFU/g

D: 10,000 CFU/g or more

### 2. 2. 2. Low-Temperature Stability

Each of the ink compositions of Examples and Comparative Examples was placed in a sample bottle and allowed to stand in a frozen state at −20° C. for a week. Then, the ink composition thawed was filtered, and precipitates formed at the low temperature were collected. The low-temperature stability of each ink composition was evaluated according to the appearance of the composition after being allowed to stand and the number of precipitates. The evaluation criteria were as follows:

### Criteria

A: The number of precipitates was less than 50 mL⁻¹.

B: The number of precipitates was 50 mL ⁻¹ to less than 200 mL⁻¹.

C: The number of precipitates was 200 mL⁻¹ or more.

D: Oil phases were formed in the ink composition.

### 2. 2. 3. Ejection Stability

Each of the ink compositions of Examples and Comparative Examples was ejected from an ink jet printer EM-930C (manufactured by Seiko Epson) through all the nozzles in a line in a thermostatic chamber of 40° C., and thus 20 sheets of paper were continuously printed. The number of nozzles that had caused missing dots or path deviation was counted for evaluation.

### Criteria

A: The number of nozzles of missing dots or deviation was 0.

B: The number of nozzles of missing dots or deviation was 1 to 5.

C: The number of nozzles of missing dots or deviation was 6 or more.

The evaluation results are shown in Table 2.

TABLE 2

| | | Example | Example | Example | Example | Example | Example | Comparative | Comparative | Comparative |
|---|---|---|---|---|---|---|---|---|---|---|
| Evaluation test | | 1 | 2 | 3 | 4 | 5 | 6 | Example 1 | Example 2 | Example 3 |
| Preservative | Escherichia coli | A | A | A | A | A | A | A | C | A |
| Effect | Pseudomonas | A | A | A | A | A | A | A | C | A |
| | aeruginosa | | | | | | | | | |
| | Aspergillus oryzae | A | A | A | A | A | A | A | C | A |
| | Penicillium | A | A | A | A | A | A | A | C | A |
| | funiculosum | | | | | | | | | |

| | | | | | | | | | |
|---|---|---|---|---|---|---|---|---|---|
| Low-temperature stability | A | A | A | A | A | A | C*1 | A | D*2 |
| Ejection stability | A | A | A | A | A | A | D | A | D |

*1Oil phase separation
*2Aggregated

In the preservative effect test, all the test strains including aerobic bacteria, anaerobic bacteria, and Eumycetes in the ink compositions of Examples 1 to 6 were sharply reduced to less than 0.1% in viable count. Examples to 6 thus exhibited strong bactericidal effect. Comparative Example 1 containing one of the first solvents and Comparative Example 3 containing sodium benzoate, which is a known preservative, exhibited strong antibacterial and antifungal effects as with Examples 1 to 6. On the other hand, in Comparative Example 2, which did not contain any first solvent or sodium benzoate, the viable count was not reduced, and thus the sample did not exhibit a sufficient preservative effect. The results of Examples 1 to 6 suggest that an ink composition containing a first solvent having a high log P value, even with a low content, can exhibit strong antibacterial and antifungal effects even though a known biocidal preservative or fungicide is not used.

In the low-temperature stability test, the ink compositions of Examples 1 to 6 did not produce precipitates or oil phases therein at a low temperature, thus exhibiting high storage stability. Comparative Example 2, which did not contain any first solvent, exhibited storage stability as with Examples 1 to 6. Comparative Example 1, in which the second solvent was replaced with methyl tetraglycol having a log P outside the range of −1.0 to 1.0, the low-temperature stability was not good because the first solvent 2-hydroxymethyl-2-phenoxymethyl-1,3-propanediol was less miscible and caused oil phase separation. The oil phases hindered the ejection of the ink composition and thus resulted in degraded ejection stability. In Comparative Example 3, which contained sodium benzoate having an aromatic ring as a preservative and fungicide, but not any first solvent, the sodium benzoate having a strong ionicity caused the pigment and resin to form an aggregate, and thus the sample was inferior in low-temperature stability.

In ejection stability test, Examples 1 to 6 exhibited such high ejection stability that the number of nozzles that had caused missing dots or path deviation was zero. Comparative Example 2 not containing a first solvent having a high log P value exhibited high ejection stability as with Examples 1 to 6. In Comparative Example 1, in which oil phases were formed therein, however, the oil phases hindered the ejection of the ink composition and thus resulted in degraded ejection stability. In Comparative Example 3, sodium benzoate having a strong ionicity caused the pigment and resin to form an aggregate, and thus the sample exhibited poor ejection stability. In Comparative examples 1 and 3, there were nozzles that caused missing dots or path deviation, and these samples thus exhibited inferior ejection stability to Examples 1 to 6.

As described above, the invention provides a safe ink not having the risk of causing skin sensitization and prevented from rotting even though a known biocidal preservative or fungicide is not used, and further exhibiting good low-temperature stability and ejection stability.

The invention is not limited to the above-described embodiments and Examples, and various modifications may be made. For example, the invention includes substantially the same form as the disclosed embodiments (for example, a form including the same function and method and producing the same result, or a form having the same purpose and producing the same effect). Some elements unessential to the form of the disclosed embodiment may be replaced. The form of an embodiment of the invention includes an element producing the same effect or achieving the same object, as the form of the disclosed embodiments. The forms of the disclosed embodiments may be combined with the known art.

The entire disclosure of Japanese Patent Application No. 2015-134945, filed Jul. 6, 2015 is expressly incorporated by reference herein.

What is claimed is:

1. A liquid composition comprising:
a first solvent with a content in the range of 0.05% by mass to 0.5% by mass, the first solvent being a propanediol compound having a water-octanol partition coefficient in the range of 0.5 to 2.0 and containing a phenoxy or a benzyloxy group;
a second solvent with a content in the range of 0.5% by mass to 15% by mass, the second solvent being a water-soluble organic solvent having a water-octanol partition coefficient in the range of −1.0 to 1.0;
water; and
a coloring material.

2. The liquid composition according to claim 1, wherein the first solvent is at least one selected from the group consisting of phenyl glyceryl ether, 2-methyl-3-phenoxy-1, 2-propanediol, 3-benzyloxy-1,2-propanediol, and 2-hydroxymethyl-2-phenoxymethyl-1,3-propanediol.

3. The liquid composition according to claim 1, wherein the second solvent is at least one selected from the group consisting of 1,2-alkyldiols and glycol ether-based water-soluble organic solvents.

4. The liquid composition according to claim 3, wherein the 1,2-alkyldiols include 1,2-butanediol, 3,3-dimethylbutane-1, 2-diol, 1,2-pentanediol, 1,2-hexanediol, and 1,2-heptanediol.

5. The liquid composition according to claim 3, wherein the glycol ether-based water-soluble organic solvents include ethyl triglycol, dipropylene glycol monomethyl ether, butyl triglycol, butyl diglycol, and dipropylene glycol monopropyl ether.

6. The liquid composition according to claim 1, wherein the water content is 40% by mass or more.

7. A pigment dispersion liquid comprising the liquid composition as set forth in claim 1.

8. A pigment dispersion liquid comprising the liquid composition as set forth in claim 2.

9. A pigment dispersion liquid comprising the liquid composition as set forth in claim 3.

10. A pigment dispersion liquid comprising the liquid composition as set forth in claim 4.

11. A pigment dispersion liquid comprising the liquid composition as set forth in claim 5.

12. A pigment dispersion liquid comprising the liquid composition as set forth in claim 6.

13. An ink jet recording aqueous ink composition comprising the liquid composition as set forth in claim 1.

14. An ink jet recording aqueous ink composition comprising the liquid composition as set forth in claim 2.

15. An ink jet recording aqueous ink composition comprising the liquid composition as set forth in claim 3.

16. An ink jet recording aqueous ink composition comprising the liquid composition as set forth in claim 4.

17. An ink jet recording aqueous ink composition comprising the liquid composition as set forth in claim 5.

18. An ink jet recording aqueous ink composition comprising the liquid composition as set forth in claim 6.
